(19) United States
(12) Patent Application Publication
(10) Pub. No.: US 2013/0081481 A1
(43) Pub. Date: Apr. 4, 2013

(54) APPARATUS FOR COUNTING COMPONENTS

(71) Applicants: In Su PARK, Gyeonggi-do (KR); Jae Youn JEONG, Gyeonggi-do (KR)

(72) Inventors: In Su PARK, Gyeonggi-do (KR); Jae Youn JEONG, Gyeonggi-do (KR)

(73) Assignee: SAMSUNG ELECTRO-MECHANICS CO., LTD., Suwon (KR)

(21) Appl. No.: 13/616,775

(22) Filed: Sep. 14, 2012

(30) Foreign Application Priority Data
Sep. 30, 2011 (KR) 10-2011-0099934

(51) Int. Cl. G01N 1/02

(52) U.S. Cl. 73/863.21

(57) ABSTRACT

Disclosed herein is an apparatus for counting components, the apparatus including: a separating part separating a plurality of components into individual components; pipes moving the components separated by the separating part therethrough; a counting part positioned on the pipes to count the components passing through the pipes; and a vacuum sucking part positioned at distal ends of the pipes. Therefore, it is possible to accurately and rapidly count the number of micro electronic components. In addition, it is possible to track loss of electronic components generated between processes by accurately and rapidly counting the electronic components.

### CROSS REFERENCE(S) TO RELATED APPLICATIONS

This application claims the benefit under 35 U.S.C. Section 119 of Korean Patent Application Serial No. 10-2011-0099934, entitled “Apparatus for Counting Components” filed on Sep. 30, 2011, which is hereby incorporated by reference in its entirety into this application.

### BACKGROUND OF THE INVENTION

1. Technical Field

The present invention relates to an apparatus for counting components, and more particularly, to an apparatus for counting components capable of accurately and rapidly counting a plurality of micro components.

2. Description of the Related Art

Generally, electronic components have a small size and light weight and are mass-produced. Particularly, electronic components such as a chip resistor, a multilayer ceramic capacitor (MLCC), or the like, have a significantly small size corresponding to only a width of about 0.4 mm and a length of about 0.2 mm. This size of the electronic component is similar to a thickness of a hair, and a shape thereof may not be distinguished with the naked eyes. In addition, the electronic components have micro-light weight of about 90 μg, such that they stick to each other by electrostatic force.

Since it takes a significant time to individually count these micro electronic components, a weight method of calculating the number of micro electronic components by selecting a single micro electronic component or some micro electronic components as a sample, measuring weight thereof, and then comparing the measured weight with weight of all micro electronic components has been used.

However, the weight method as described above has a fatal disadvantage in which since it approximately calculate the number of micro electronic components using the weight rather than the number, it is impossible to accurately recognize the number of micro electronic components. Therefore, it is difficult to maintain component loss between processes.

Further, in accordance with the trend toward precision and miniaturization of the electronic components, measurement of the electronic components using the weight method has also become difficult. Therefore, in order to analyze and manage a cause of component loss between processes by measuring the number of components that will become precise and miniaturized in the future, the demand for the development of an apparatus for counting components capable of individually and accurately measuring the number of components has increased.

### SUMMARY OF THE INVENTION

An object of the present invention is to provide an apparatus for counting components capable of rapidly and accurately measuring the number of micro components.

According to an exemplary embodiment of the present invention, there is provided an apparatus for counting components, the apparatus including: a separating part separating a plurality of components into individual components; pipes moving the components separated by the separating part therethrough; a counting part positioned on the pipes to count the components passing through the pipes; and a vacuum sucking part positioned at distal ends of the pipes.

The apparatus may further include first vibrating parts vibrating the separating part, and the separating part may be provided with line shaped grooves corresponding to paths through which the individual components are lined up in a row and then move to the pipes.

The number of the line shaped grooves and the pipes may be plural.

The separating part may be provided with guide parts positioned between the line shaped grooves adjacent to each other and guiding the components to the line shaped grooves.

The separating part may be subjected to an anodizing process, and the separating part may be subjected to a sealing process in order to cover micro holes of a surface thereof.

The apparatus may further include a supplying part storing a plurality of components therein and supplying the components to the separating part and a second vibrating part vibrating the supplying part.

The apparatus may further include a weight sensing sensor sensing weight of the supplying part.

The supplying part may include a bracket having a plurality of holes formed therein, and the components may fall to the separating part while passing through the holes.

The counting part may count the components using a photo sensor.

The apparatus may further include a component storing part connected to the distal ends of the pipes and storing components for which counting is completed therein, and the vacuum sucking part may be connected to the pipes through the component storing part.

The apparatus may further include a third vibrating part vibrating the pipes.

### BRIEF DESCRIPTION OF THE DRAWINGS

FIG. 1 is a side view of an apparatus for counting components according to an exemplary embodiment of the present invention;

FIG. 2 is a perspective view showing the supplying part and the separating part shown in FIG. 1;

FIG. 3 is a partially enlarged view of the supplying part and the separating part shown in FIG. 2; and

FIG. 4 is a partially enlarged view of the counting part shown in FIG. 1.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

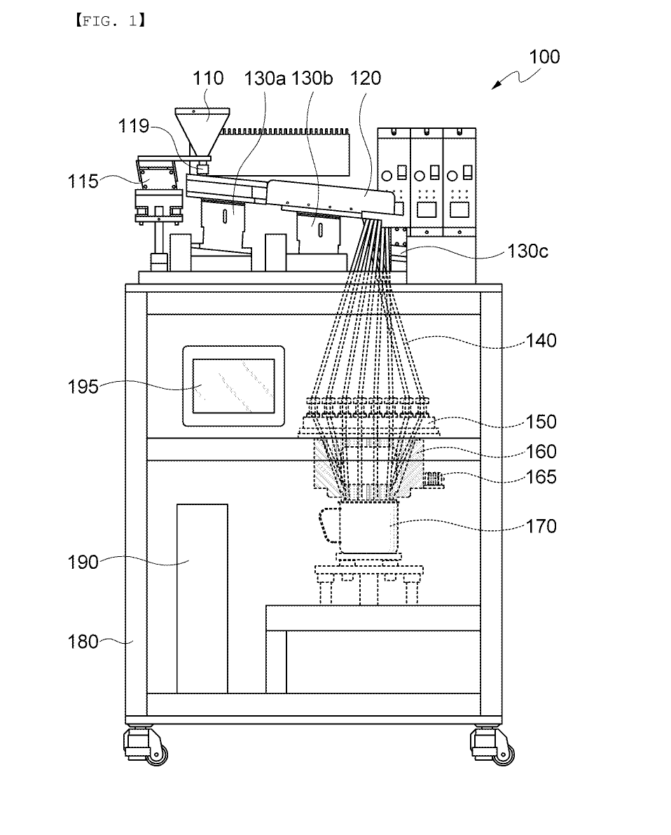

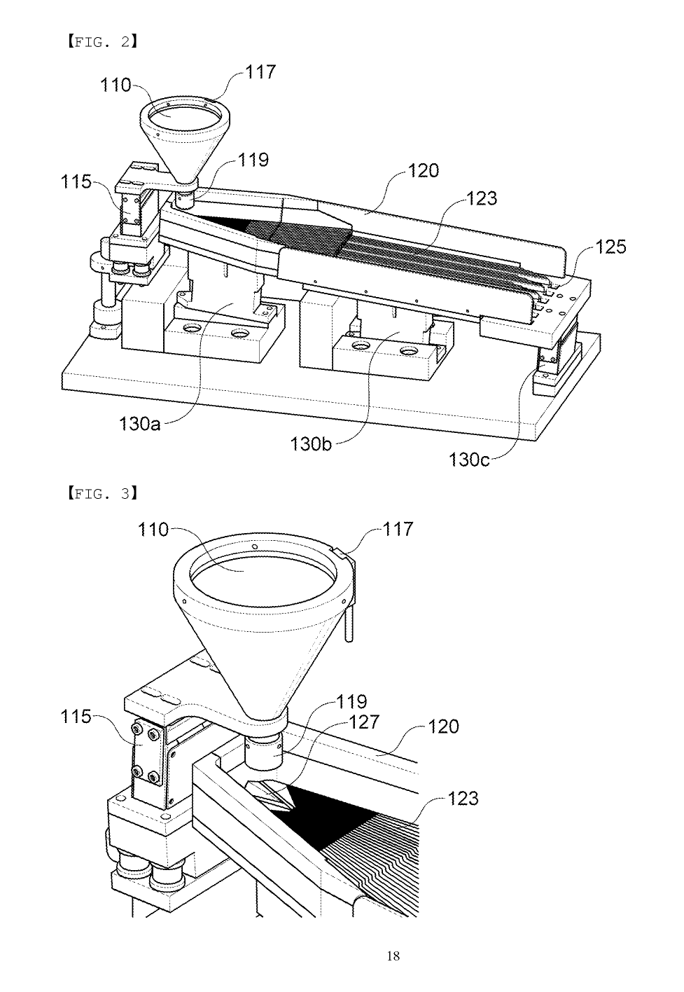

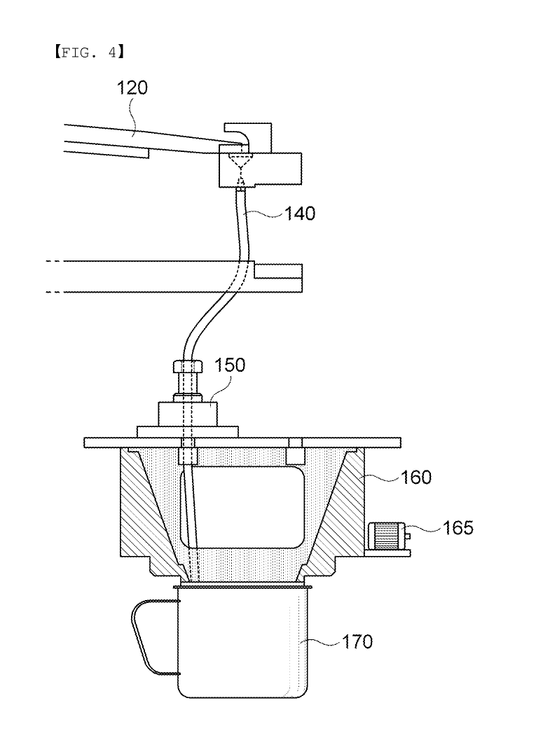

FIG. 1 is a side view of an apparatus for counting components according to an exemplary embodiment of the present invention; FIG. 2 is a perspective view showing a supplying part and a separating part shown in FIG. 1; FIG. 3 is a partially enlarged view of the supplying part and the separating part shown in FIG. 2; and FIG. 4 is a partially enlarged view of a counting part shown in FIG. 1.

Referring to FIGS. 1 to 4, the apparatus 100 for counting components according to the exemplary embodiment of the present invention is configured to include a separating part 120, pipes 140, a counting part 150, and a vacuum absorbing sucking part 160.

The separating part 120 serves to separate a plurality of components to be counted into individual components. This separating part 120 has an inclined structure in which one side thereof is high and the other side thereof is low, such that the components to be counted are separated into the individual components while moving along the inclination of the separating part.

In addition, the components separated into the individual components by the separating part 120 moves to the pipes 140 through pipe connection holes 125 formed at the other side of the separating part 120. The pipes 140 are installed to be stand up in a vertical direction, and the components moved to the pipes moves to distal ends of the pipes while falling through inner portions of the pipes 140.

Meanwhile, the pipe 140 has the counting part 150 positioned thereon in order to count the components passing therethrough. The counting part 150 serves to count the components passing through the pipes using a photo sensor, or the like.

In addition, the pipe 140 has the vacuum sucking part 160 positioned at the distal end thereof. This vacuum sucking part 160 may be a vacuum pump using a motor 165. This vacuum pump serves to adsorb air of the inner portions of the pipes 140, which pulls the components of the inner portions of the pipes 140.

Therefore, the components introduced into the pipes 140 pass through the counting part 150 while moving in the inner portions of the pipes 140 at a speed much more rapid than a free fall speed, thereby making it possible to significantly increase a counting speed.

In addition, the components are pulled using the vacuum sucking part 160, thereby making it possible to prevent a phenomenon that the components are attached to inner sides of the pipes 140 by static electricity, or the like, such that the pipes 140 are blocked or the components do not arrive at the counting part 150. Therefore, all components pass through the counting part 150, such that counting accuracy is significantly improved.

As described above, the apparatus 100 for counting components according to the exemplary embodiment of the present invention pulls the components using the vacuum sucking part 160, thereby making it possible to accurately count the component at a rapid speed.

Meanwhile, the apparatus 100 for counting components according to the exemplary embodiment of the present invention may further include first vibrating parts 130a and 130b vibrating the separating part 120. These first vibrating parts 130a and 130b vibrates the separating part 120 at a high frequency using a high frequency vibrator, and counting object components positioned in the separating part 120 moves by the vibration. In addition, this high frequency vibration is transferred to the components, thereby making it possible to further improve a separating effect between components attached to each other.

Although a case in which two first vibrating parts 130a and 130 are mounted on a lower portion of the separating part 120 has been described, two or more fist vibrating parts 130a and 130b may also be mounted according to a size of the separating part 120, or the like.

In addition, the separating part 120 includes line shaped grooves 123 formed in a longitudinal direction thereof. The components moves toward the pipes 140 along the line shaped grooves 123 while being separated. The components are lined up in a row while moving along the line grooves 123, and the lined components are sequentially introduced into the pipes 140.

The number of line shaped groove 123 may be plural, and the number of pipes 140 may also be plural so as to correspond to the number of line shaped grooves 123. Since the components move in a parallel form along the plurality of line shaped grooves 123 and pipes 140, a large number of components may be processed at a time.

Furthermore, the separating part 120 may further include a guide part positioned between the line shaped grooves 123 adjacent to each other and guiding the components to the line shaped grooves 123. This guide part may have an upwardly sharply protruded shape so that components positioned at positions other than the line shaped grooves 123 may move to the line shaped groove 123.

The separating part 120 may be subjected to an anodizing process. The anodizing process, which is a surface post-treatment scheme of aluminum, means a process of coating an oxide coating on a surface of aluminum through an electrochemical reaction. The aluminum is weak in terms of physical and chemical properties, such that it is easily changed in quality and corroded. Therefore, in order to prevent the change in quality and the corrosion of the aluminum, the anodizing is performed.

In addition, the separating part 120 is subjected to a sealing process in order to cover micro holes of a surface thereof. The micro holes remaining after the separating part 120 is anodized is sealed, thereby making it possible to prevent a residual component, a foreign material, or the like, from being adhered to the separating part 120.

Meanwhile, the apparatus 100 for counting components according to the exemplary embodiment of the present invention may further include a supplying part 110. The supplying part 110 serves to store a plurality of components before being separated therein and supply the components to be counted to the separating part 120.

Here, the supplying part 110 may be positioned on the separating part 120 and be a hopper having a funnel shape. The supplying part 110 allows the components stored therein to fall while vibrating by a second vibrating part 115, thereby supplying the component to be counted to the separating part 120.

In addition, the apparatus 100 for counting components according to the exemplary embodiment of the present invention may further include a weight sensing sensor sensing weight of the supplying part 110. The weight of the supplying part 110 is changed while the components stored in the supplying part 110 are supplied to the separating part 120. At this time, a resonant frequency is also changed, such that the number of components supplied to the separating part 120 is changed.

According to the exemplary embodiment of the present invention, a vibration frequency of the second vibrating part 115 is controlled while a change in weight of the supplying part 110 is measured in real time through the weight sensing sensor 117, thereby making it possible to maintain the resonant frequency of the supplying part 110 so as to be constant. Therefore, the components may be supplied to the separating part 120 so as to be constant regardless of the number of components stored in the supplying part.

In addition, the supplying part 110 may further include a bracket 119 having a plurality of holes formed therein. The bracket 119 is positioned at a lower end of the supplying part 110, and the components fall to the separating part 120 while passing through the holes formed in the bracket 119. Since the plurality of holes are dispersed and positioned, the components are dispersed and fall to the separating part 120 according to positions of the holes. Therefore, the components may be uniformly dispersed and supplied.

In addition, the separating part 120 may be provided with a diffusing part 127 protruded in a trigonal pyramid shape at a portion to which the components fall from the supplying part 110. The components falling from the supplying part 110 are more uniformly dispersed by an inclined surface of this diffusing part 127.

Meanwhile, the counting part 150 may count the components using the photo sensor. Since the photo sensor may count the component in a contactless scheme, it does not have an influence on movement of the components. In addition, since the photo sensor does not include a physical driving part, it has a rapid response speed, such that it may be rapidly count a number of components.

In addition, the apparatus 100 for counting components according to the exemplary embodiment of the present invention may further include a component storing part 170 connected to the distal ends of the pipes 140 and storing components for which counting is completed therein. Since the component storing part 170 stores the components for which the counting is completed and that are discharged through the distal ends of the pipes 140 therein, it facilitates treatment of the components for which the counting is completed.

In addition, the vacuum sucking part 160 may be connected to the pipes 140 through the component storing part 170. In the case in which the vacuum sucking part 160 is directly connected to the pipes 140, the components passing through the pipes 140 may be sucked into the vacuum sucking part 160. Therefore, it is difficult to retrieve the components for which the counting is completed. Therefore, the vacuum sucking part 160 is connected to the pipes 140 through the component storing part 170, thereby making it possible to prevent the components discharged from the pipes 140 from being sucked into the vacuum sucking part 160.

As an additional method for preventing the components from being sucked into the vacuum sucking part 160, an air filter may be mounted in the vacuum sucking part 160. In this case, even though the components are sucked into the vacuum sucking part 160, they are filtered by the air filter, thereby making it possible to prevent loss of the components or a fault of the vacuum sucking part 160.

Meanwhile, the apparatus 100 for counting components according to the exemplary embodiment of the present invention may further include a third vibrating part 130c vibrating the pipes 140. This third vibrating part 130c is mounted at portions corresponding to the pipe connection holes 125 to vibrate the pipes 140. The pipes 140 vibrate, thereby making it possible to prevent a phenomenon that the components are attached to the inner sides of the pipes 140 by static electricity, or the like. That is, the third vibrating part 130c allows the components to smoothly pass through the pipes 140, thereby making it possible to increase a counting speed and counting accuracy.

For reference, the apparatus 100 for counting components according to the exemplary embodiment of the present invention may further include a controlling part 190 controlling the first vibrating parts 130a and 130b, the second vibrating part 115, the counting part 150, and the vacuum sucking part 160, and a display 195 outputting various information such as the number of counted components, a counting time, or the like. In addition, the apparatus 100 for counting components according to the exemplary embodiment of the present invention may further include a body part 180 having a movable wheel mounted at a lower portion thereof so as to be easily moved and mounted.

With the apparatus for counting components according to the exemplary embodiments of the present invention, it is possible to accurately and rapidly count the number of micro electronic components.

In addition, it is possible to track loss of electronic components generated between processes by accurately and rapidly counting the electronic components.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An apparatus for counting components, the apparatus comprising:
a separating part separating a plurality of components into individual components;
pipes moving the components separated by the separating part therethrough;
a counting part positioned on the pipes to count the components passing through the pipes; and
a vacuum sucking part positioned at distal ends of the pipes.

2. The apparatus according to claim 1, further comprising first vibrating parts vibrating the separating part.

3. The apparatus according to claim 1, wherein the separating part is provided with line shaped grooves corresponding to paths through which the individual components are lined up in a row and then move to the pipes.

4. The apparatus according to claim 3, wherein the number of the line shaped grooves and the pipes is plural.

5. The apparatus according to claim 3, wherein the separating part is provided with guide parts positioned between the line shaped grooves adjacent to each other and guiding the components to the line shaped grooves.

6. The apparatus according to claim 1, wherein the separating part is subjected to an anodizing process.

7. The apparatus according to claim 1, wherein the separating part is subjected to a sealing process in order to cover micro holes of a surface thereof.

8. The apparatus according to claim 1, further comprising a supplying part storing a plurality of components therein and supplying the components to the separating part.

9. The apparatus according to claim 8, further comprising a second vibrating part vibrating the supplying part.

10. The apparatus according to claim 8, further comprising a weight sensing sensor sensing weight of the supplying part.

11. The apparatus according to claim 8, wherein the supplying part includes a bracket having a plurality of holes formed therein, and the components fall to the separating part while passing through the holes.

12. The apparatus according to claim 1, wherein the counting part counts the components using a photo sensor.

13. The apparatus according to claim 1, further comprising a component storing part connected to the distal ends of the pipes and storing components for which counting is completed therein.

14. The apparatus according to claim 13, wherein the vacuum sucking part is connected to the pipes through the component storing part.

15. The apparatus according to claim 1, further comprising a third vibrating part vibrating the pipes.
